(19) United States
(12) Patent Application Publication
(10) Pub. No.: US 2023/0356395 A1
(43) Pub. Date: Nov. 9, 2023

(54) ROBOTIC ASSEMBLY OPTIMIZATION

(71) Applicant: International Business Machines Corporation, Armonk, NY (US)

(72) Inventors: Subha Kiran Patnaikuni, Visakhapatnam (IN); Sarbajit K. Rakshit, Kolkata (IN)

(21) Appl. No.: 17/661,915

(22) Filed: May 3, 2022

(51) Int. Cl. G05B 19/4155; B25J 9/16

(52) U.S. Cl. CPC B25J 9/1664; G05B 19/4155; G05B 2219/45064

(57) ABSTRACT

A processor may receive assembly data associated with one or more assembly robots and an object. The object may be assembled by the one or more assembly robots performing one or more assembly maneuvers. The processor may analyze the assembly data and the one or more assembly maneuvers associated with assembling the object. The processor may identify one or more alterable factors associated with the one or more assembly maneuvers. The processor may generate an optimized assembly plan based, at least in part, on altering the one or more alterable factors associated with the one or more assembly maneuvers. The processor may assemble the object based on the optimized assembly plan.

### BACKGROUND

Aspects of the present disclosure relate generally to the field of artificial intelligence, and more particularly to assembling objects using robotics.

As technology associated with robotics has advanced, a greater understanding of how robotics can be applied to different industrial operation has also developed. The area of robotics has been used to revolutionize industrial manufacturing and assembly of various products. While the term robotics covers a cornucopia of devices and technology, often a common example of robotic devices used in manufacturing and assembling operations is the robotic arm. In such operations, robotic arms may be synchronized to move and assemble a product in concert with other robotic arms.

### SUMMARY

Embodiments of the present disclosure include a method, computer program product, and system for optimizing robotic assembly.

A processor may receive assembly data associated with one or more assembly robots and an object. The object may be assembled by the one or more assembly robots performing one or more assembly maneuvers. The processor may analyze the assembly data and the one or more assembly maneuvers associated with assembling the object. The processor may identify one or more alterable factors associated with the one or more assembly maneuvers. The processor may generate an optimized assembly plan based, at least in part, on altering the one or more alterable factors associated with the one or more assembly maneuvers. The processor may assemble the object based on the optimized assembly plan.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example robotic assembly system, in accordance with aspects of the present disclosure.

FIG. 2 illustrates a flowchart of an example method for optimizing robotic assembly in a smart environment, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence, and, more particularly, to assembling object using robotics. While the present disclosure is not necessarily limited to such applications, various aspects of the disclosure may be appreciated through a discussion of various examples using this context.

Robotics have revolutionized how various objects are manufactured and assembled. Robotics are not only used to assemble small objects, but can also be used to assemble and manufacture large machines and structures. While the term robotics covers numerous types of devices and technology, a common example of robotic devices used in manufacturing and assembling operations is the robotic arm. While various embodiments contemplated herein refer to the use of a robotic arm or other mechanisms, such embodiments are used as examples only and should not be construed as limiting. Robotic arms have been shown to be successfully used for the assembly of large structures, such as using steel trusses to construct various structures (e.g., bridges, ramps, buildings, etc.).

While robotic arms and other such robotic devices have shown to be effective at assembling objects, often these robotic devices perform unnecessary movements and maneuvers during the manufacturing or assembling process. These unnecessary movements and maneuvers can result in an increase in production time (e.g., assembly and/or manufacturing time) and a decrease in productivity. For example, traditional methods of assembling a roof using steel trusses often use a robotic arm. Traditionally, the robotic arm would be required to travel from one base side of the steel tress to the other gradually building on each side until the two sides meet to form a completed steel truss. As a result of the inefficient traveling between disparate ends or sides of the steel tress, often result in a significant increase in time to build the steel tress and a decrease in productivity. As such, there is a desire for a solution that provides the benefits of robotic assembly while also optimizing the various maneuvers performed by the robotic device to increase productivity and minimize inefficiencies.

Before turning to the FIGS. it is noted that the benefits/novelties and intricacies of the proposed solution are that:

The robotic assembly system may be configured with a robotic swarm base. The robotic assembly system may identify the structure, dimensions, shape of any object or work product to be assembled. In embodiments, the robotic swarm base may be configured by the robotic assembly system to dynamically reposition as the robotic swarm base performs the assembling process, in such a way as to minimize the movement of project material and the movement of the robotic arm during assembly.

The robotic assembly system may be configured to identify how many robotic swarm bases may be required to assemble an object or product, based on the shape, dimension, and weight of the object or work product. In some embodiments, the robotic assembly system may identify the optimum amount of robotic swarm bases that may be used to assemble the object or work product to minimize the time needed to complete the assembly.

The robotic assembly system may collect/receive robotic data (e.g., progress of assembling process, speed of assembling process, etc.). The robotic assembly system may analyze robotic data and determine the direction of movement and speed of movement of the robotic arm that provide for a minimized idle time.

The robotic assembly system may perform appropriate types of mobility (e.g., linear movement, rotational movement etc.) to minimize possible robotic arm idle times. The robotic assembly system may be based on the sequence of assembling, dimensions of the object, and shape of the object to be assembled.

The robotic assembly system may use historical learning to identify, during object assembly, how the assembly process should be performed. For example, the robotic assembly system may identify the position the robotic arm should be positioned and where the raw materials should be positioned to optimize assembly time.

They robotic assembly system may be configured to collaboration between the robotic swarm base modules and the robotic arm. This collaboration may enable the robotic assembly system to identify when the robotic swarm base should perform particular movements during object assembly. In some embodiments, the robotic assembly system may analyze the robotic data (e.g., using historical learning) to generate a knowledge corpus.

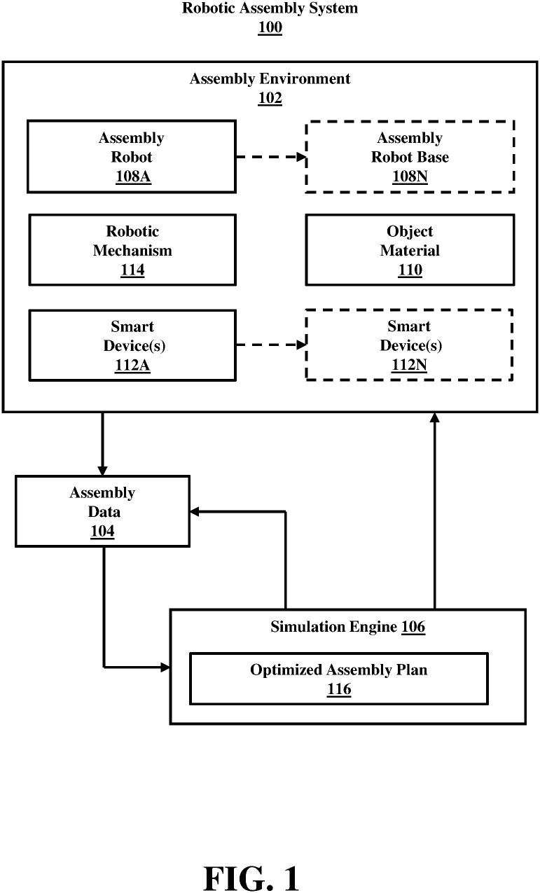

Referring now to FIG. 1, illustrated is a block diagram of an example robotic assembly system 100 for optimizing robotic assembly, in accordance with aspects of the present disclosure. for controlling. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

As depicted in FIG. 1, robotic assembly system 100 may be configured to include assembly environment 102, assembly data 104, and simulation engine 106. In embodiments, assembly environment 102 may refer to any space or area where one or more objects may be assembled or manufactured. For example, assembly environment 102 may include, but are not limited to industrial floors of a factory or outdoor construction sites. Assembly environment 102 may be configured to include one or more assembly robots 108A-N, object material 110, one or more smart device(s) 112A-N, and robotic mechanism 114.

In embodiments, one or more assembly robots 108A-N may be configured in a variety of ways to perform object assembling. In some embodiments, one or more assembly robots 108A-N may be configured as robotic swarm bases configured to move throughout assembly environment 102 to perform various assembly maneuvers (e.g., instructions to move in a particular direction or perform a particular assembly task) or self-mobility (e.g., optimized assembly plan 116). One or more assembly robots 108A-N, such as those configured as robotic swarm bases, may have locking mechanisms that enable to one or more assembly robots 108A-N to be locked when not performing maneuvers and released when performing maneuvers. In some embodiments, some or all of the one or more assembly robots 108A-N may have a clamping mechanism that may be used to secure the object, or portion of object, during object assembly.

While in some embodiments, each of the one or more assembly robots 108A-N is configured the same with the same or similar capabilities, in other embodiments, some of the one or more assembly robots 108A-N may be configured with different capabilities or different types of robotic assembly devices. For example, in some embodiments, one or more assembly robots 108A-N may include robot mechanisms 114. Though, as depicted in FIG. 1, robotic mechanism 114 may be configured independently from the one or more assembly robots 108A-N, in other embodiments, robotic mechanism 114 may be configured on or within one or more assembly robots 108A-N (e.g., robotic mechanism 114 configured on a robotic swarm base) and configured to move throughout assembly environment 102. In embodiments, robotic mechanism 114 may include devices, such as robotic arms, that perform particular assembly functions. Robotic mechanisms 114 may be stationary within assembly environment 102 or configured to move throughout assembly environment 102.

In embodiments, robotic assembly system 100 may be configured to receive assembly data 104 from assembly environment 102. Assembly data 104 may be associated with one or more assembly robots 108A-N and an object. In embodiments, robotic assembly system 100 may assemble the object from object material 110 by configuring one or more assembly robots 108AN to perform one or more assembly maneuvers (e.g., based on optimized assembly plan 116). Assembly data may include, but is not limited to, information or data associated with: i) the configuration of assembly environment 102 (e.g., factor or worksite layout); ii) the number and types of assembly robots 108A-N and/or robotic mechanisms 114 configured within assembly environment 102 (e.g., capabilities and configurations of assembly robots 108A-N and/or robotic mechanisms); iii) position/location of each assembly robots 108A-N and/or robotic mechanisms 114, object materials (e.g., raw materials used to assemble/construct the object), and/or one or more smart devices 112A-N that may be used within assembly environment 102; iv) number and type of different object materials 110 that may be used to assemble/construct the object of interest; v) information associated with assembling the object; vi) real-time information associated with the object assembly process (e.g., new data that may be used to update the optimized assembly plan ; vii) information/data generated from various analyses contemplated herein (e.g., information/data generated by AI and machine learning analysis via simulation engine 106); viii), and databases having information/data associated with the assembly/construction of the same or similar object, such as data relating to how much time was needed to assemble/construct previous objects and how one or more factors (e.g., alterable factors) may impact the assembly/construction of the object (e.g., factors that may increase time needed to complete object assembly).

In embodiments, robot assembly system 100 may be configured to store assembly data collected over time in a historical repository. The historical repository may include any assembly data contemplated herein. In embodiments, robot assembly system 100 may access the historical repository to generate one or more simulations using AI and machine learning capabilities (e.g., simulation engine 106). The information generated from these analyses may be considered assembly data and may also be stored within the historical repository.

In embodiments, robot assembly system 100 may receive/collect assembly data 104 from one or more smart devices 112A-N. Smart devices 112A-N may include, but are not limited to devices such as, Internet of Things (IoT) devices, cameras, infrared sensors, ultrasounds, chemical sensors, wearable devices (e.g., device worn into the assembly environment 102 by a user), or any combination thereof. In embodiments, robot assembly system 100 may configure one or more smart devices 112A-N to receive/collect assembly data 104 associated with assembly environment 102 in real-time and/or to collect assembly data 104 over a particular time duration. Such assembly data 104 may be stored in a historical repository and accessed as needed by robot assembly system 100 by simulation engine 106 (e.g., when using AI and machine learning capabilities performing the various simulations/analyses contemplated herein). While some smart devices 112A-N may be configured within the assembly environment 102, in some embodiments, other smart devices 112A-N may be further configured within or associated with assembly robots 108A-N and/or robotic mechanism 114.

In embodiments, robot assembly system 100 may analyze assembly data 104 using simulation engine 106 enabled to perform AI and machine learning analyses. While in some embodiments, robot assembly system 100 may receive one or more assembly maneuvers associated with assembling the object of interest from a database (e.g., assembly data), in other embodiments, robot assembly system 100 may analyze historical assembly data from the historical repository and determine the one or more assembly maneuvers that may be needed to assemble or construct the object of interest (e.g., via one or more simulations). In some embodiments, robot assembly system 100 may configure simulation engine 106 to generate one or more simulations of assembly environment 102 using assembly data 104. These simulations may be based on assembly data received collected in real-time and/or retreived from the historical repository.

In embodiments, robot assembly system 100 may be configured to analyze the assembly data and the one or more assembly maneuvers associated with assembling/constructing the object of interest (e.g., simulation engine 106). Robot assembly system 100 may use these analyses or simulations to identify one or more alterable factors associated with the one or more assembly maneuvers. One or more alterable factors may refer to any aspect of assembly environment 102 and/or the object that may be altered to increase assembling productivity and/or efficiency. Alterable factors may include, but are not limited to, increasing/decreasing the number of assembly robots 108A-N and/or the number of robot mechanisms 114, changing the position of object materials 110 within assembly environment 102 (e.g., moving the object material closer to the robot mechanism 114), removing or adding maneuvers from the one or more assembly maneuvers, and reconfiguring the one or more assembly robots 108A-N and/or robot mechanisms 114, based on allowed technical capabilities, to perform different maneuvers.

In embodiments, robot assembly system 100 may generate optimized assembly plan 116 using simulation engine 106. Optimized assembly plan 116 may be based, at least in part, on altering the one or more alterable factors previously identified (e.g., via simulation engine 106). Optimized assembly plan 116 may provide one or more assembly instructions for a particular object within a particular assembly environment 102 to be assembled productively and efficiently. These assembly instructions may include, but are not limited to, using an efficient number of assembly robots 108A-N and/or the number of robot mechanisms 114 (e.g., using two robotic arms and 10 robotic swarm bases is the optimized number of devices), instructions indicating where within assembly environment 102 of object materials 110 should be positioned and/or the amount or object materials 110 that may be needed in each location (e.g., a particular amounts of object material 110 should be positioned within reach of the two robotic arms), what maneuvers the one or more assembly robots 108A-N should perform to timely assemble the object (e.g., removing unnecessary maneuvers from the one or more assembly maneuvers to mitigate assembly delays), how the one or more assembly robots 108A-N and/or robot mechanisms 114 should be reconfigured to perform the identified maneuvers (e.g., should a robotic swarm base be locked in place or used to clamp the object during assembly), or any combination thereof. In embodiments, simulation engine 106 may base optimized assembly plan 116 on timeliness and/or resource availability (e.g., the number of one or more assembly robots 108A-N and/or robot mechanisms 114 available to perform object assembly).

In one example embodiment, robot assembly system 100 may base generating optimized assembly plan 116 on simulating a particular assembly maneuver of the one or more assembly maneuvers using simulation engine 106. Using these simulations, robot assembly system 100 may determine an amount of time associated with performing the particular assembly maneuver (e.g., alterable factor). Robot assembly system 100 may use the aforementioned simulations and assembly data 104 to identify a substitute assembly maneuver that results in the same assembly outcome (e.g., step of assembling the object) but is able to be performed in a different amount of time (e.g., smaller amount of time). In such embodiments, robot assembly system 100 may replace the particular assembly maneuver with the substitute assembly maneuver if robot assembly system 100 determines that the different amount of time associated with the substitute assembly maneuver is less than the amount of time of the particular assembly maneuver. As such, the particular assembly maneuver may be replaced with the substitute assembly maneuver in optimized assembly plan 116 to minimize production time (e.g., increase productivity).

In another embodiment, robot assembly system 100 may base generating optimized assembly plan 116 on simulating assembly data and the one or more assembly maneuvers associated with assembling the object using simulation engine 106. In these embodiments, robot assembly system 100 may determine an amount of assembly time associated with assembling the object using an initial number of the one or more assembly robots 108A-N (e.g., the initial number of the one or more assembly robots is an alterable factor). In these embodiments, robot assembly system 100 may use this amount of assembly time associated with an initial number of the one or more assembly robots 108A-N to simulate how and whether the increase or decrease number of assembly robots may result in an increase in object assembly efficiency and productivity. In embodiments where robot assembly system 100 determines there is an increase in object assembly efficiency and productivity when the number of assembly robots is altered, robot assembly system 100 may identify (e.g., via simulation engine 106) an optimized number of the one or more assembly robots that should be utilized to perform assembly of the object.

In embodiments, robot assembly system 100 may assemble the object of interest based on the optimized assembly plan. Robot assembly system 100 may perform object assembly by issuing instructions to one or more assembly robots 108A-N and/or robot mechanisms 114 to perform optimized assembly plan 116. In such embodiments, robotic assembly system 100 may dynamically reposition the one or more assembly robots 108A-N (e.g., robotic swarm bases and/or robotic mechanism), based on optimized assembly plan 116. In some embodiments, based on the availability of one or more assembly robots 108A-N, robot assembly system 100 may generate an optimized assembly plan 116 where robotic swarm bases are configured to hold and change the position and/or orientation of an object during assembly as a robotic mechanism 114 is performing assembly steps. In these embodiments, the robotic mechanism 114 (e.g., robotic arm) may be stationary with object material positioned (e.g., as indicated by the optimized assembly plan) proximate to the robotic mechanism within easy reach during assembly.

In some embodiments, robot assembly system 100 may receive and analyze real-time assembly data (e.g., via simulation engine 106) as one or more assembly robots assemble the object as dictated by optimized assembly plan 116 (e.g., by analyzing/simulating the object during assembly by the shape and dimensions of the object as it is assembled).

In such embodiments, robot assembly system 100 may identify a change associated with assembly environment 102 that may affect the object’s assembly has occurred. For example, a change may include failure of one of the one or more assembly robots 108A-N needed to perform one or more maneuvers associated with the optimized assembly plan. In embodiments, robot assembly system 100 may simulate the change and the optimized assembly plan, using simulation engine 106, to determine the impact of the change on the object’s assembly. In such embodiments, robot assembly system 100 may update optimized assembly plan 116 (e.g., updated optimized assembly plan) based on the impact simulated. For example, simulation engine 106 may simulate how the failure of one assembly robot will impact the productivity and efficiency of the object assembly (e.g., failed assembly robot will not be able to perform previously assigned assembly maneuvers) and generate additional instructions (e.g., reassign assembly maneuvers from failed assembly robot to another working assembly robot) that enable the remaining assembly robots of the one or more assembly robots 108A-N to complete the object’s assembly (e.g., in as efficient manner as possible based on the change). In such embodiments, robot assembly system 100 may dynamically reposition one or more assembly robots 108A-N (e.g., those assembly robots remaining) within assembly environment 102 based on the updated optimized assembly plan.

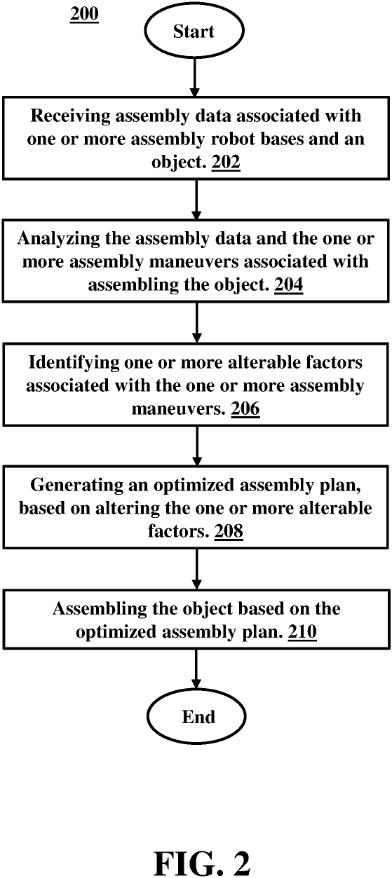

Referring now to FIG. 2, a flowchart illustrating an example method 200 for optimizing robotic assembly, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where a processor may receive assembly data associated with one or more assembly robots and an object. In embodiments, the object may be assembled by the one or more assembly robots performing one or more assembly maneuvers. In some embodiments, the method 200 proceeds to operation 204.

At operation 204, a processor may analyze the assembly data and the one or more assembly maneuvers associated with assembling the object. In some embodiments, the method 200 proceeds to operation 206.

At operation 206, a processor may identify one or more alterable factors associated with the one or more assembly maneuvers. In some embodiments, the method 200 may proceed to operation 208.

At operation 208, a processor may generate an optimized assembly plan based, at least in part, on altering the one or more alterable factors associated with the one or more assembly maneuvers. In some embodiments, the method 200 may proceed to operation 210.

At operation 208, a processor may assemble the object based on the optimized assembly plan. In some embodiments, as depicted in FIG. 2, after operation 208, the method 200 may end.

In some embodiments, discussed below there are one or more operations of the method 200 not depicted for the sake of brevity and which are discussed throughout this disclosure. Accordingly, in some embodiments, the processor may generate one or more simulations associated with the object and assembly data. The optimized assembly plan may be based on the one or more simulations.

In some embodiments, the processor may dynamically reposition the one or more assembly robots, based on the optimized assembly plan.

In some embodiments, the processor may analyze the assembly data to identify a change associated with the object has occurred. In these embodiments, the processor may simulate the change and the optimized assembly plan to determine an impact of the change on the optimized assembly plan. In these embodiments, the processor may update the optimized assembly plan based on the impact to form an updated optimized assembly plan. The processor may then dynamically reposition the one or more assembly robots based on the updated optimized assembly plan.

In some embodiments, the process or may simulate a particular assembly maneuver of the one or more assembly maneuvers to determine an amount of time associated with performing the particular assembly maneuver. The amount of time may be an alterable factor. In these embodiments, the processor may identify a substitute assembly maneuver. The substitute assembly maneuver may be performed in a different amount of time. In these embodiments, the processor may determine the different amount of time associated with the substitute assembly maneuver is less than the amount of time of the particular assembly maneuver and replace the particular assembly maneuver with the substitute assembly maneuver.

In some embodiments, the processor may generate the optimized assembly plan by simulating the assembly data and the one or more assembly maneuvers associated with assembling the object. The processor may then determine an assembly time associated with assembling the object using an initial number of the one or more assembly robots. The the initial number of the one or more assembly robots may be an alterable factor. In these embodiments, the processor may then identify an optimized number of the one or more assembly robots. The optimized number of the one or more assembly robots may be based on simulating the assembly data and the one or more assembly maneuvers associated with assembling the object.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

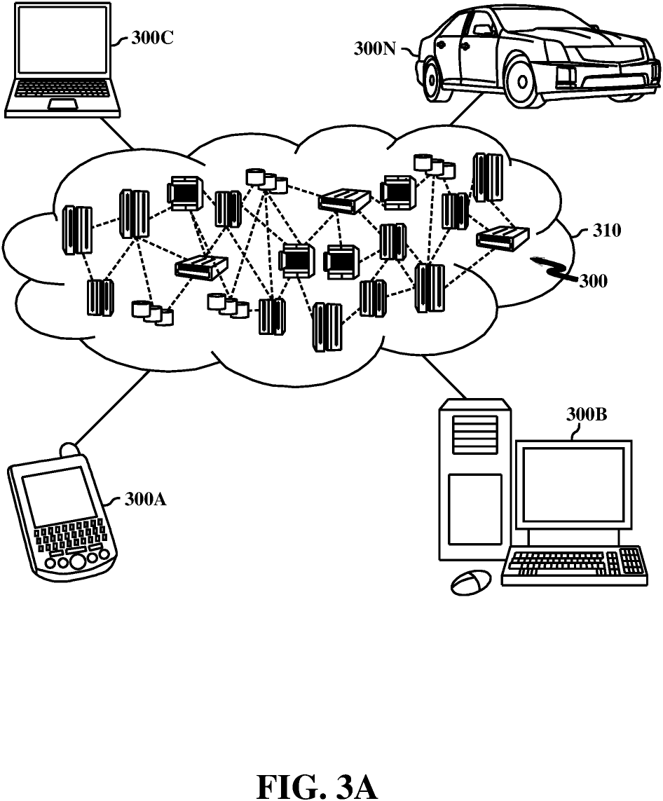

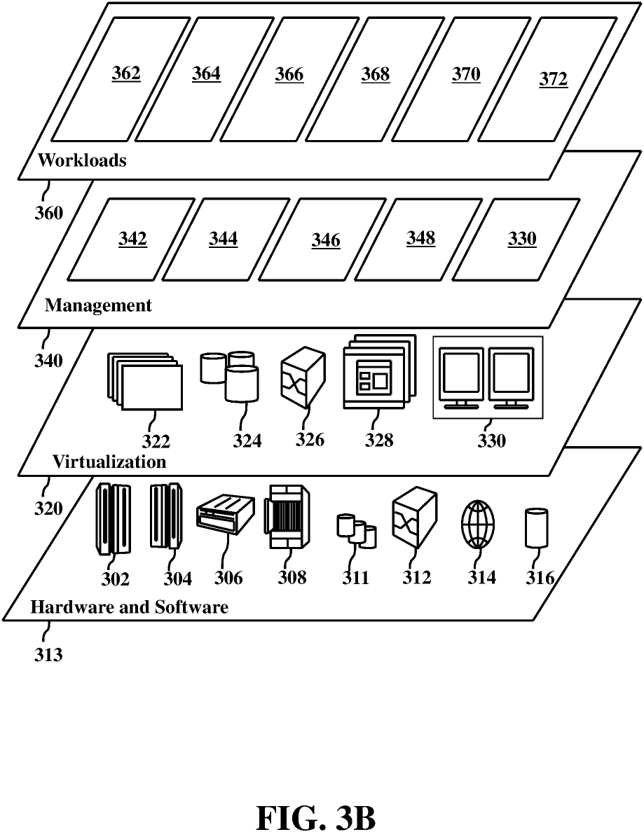

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and robotic assembly optimization 372.

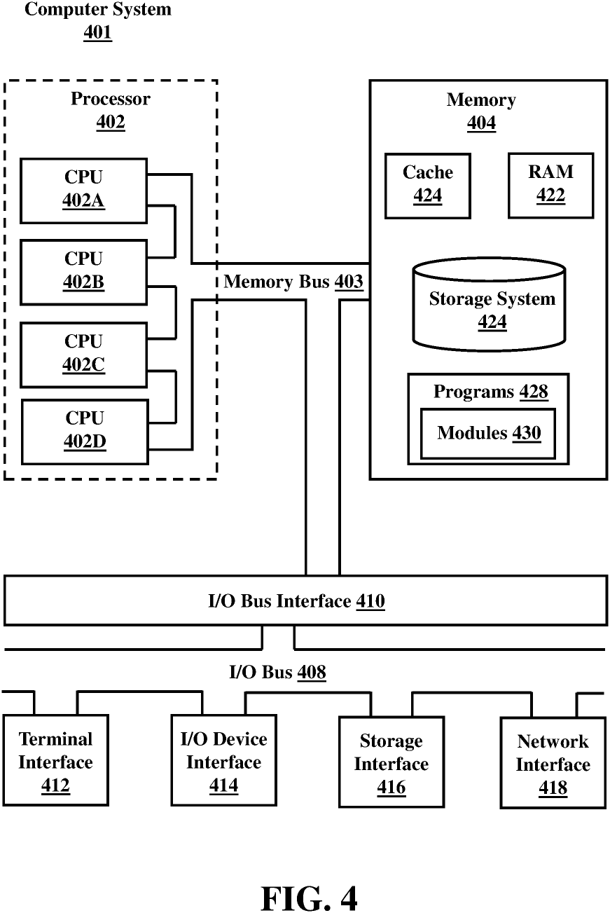

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, assembly data associated with one or more assembly robots and an object, wherein the object is assembled by the one or more assembly robots performing one or more assembly maneuvers;
analyzing the assembly data and the one or more assembly maneuvers associated with assembling the object;
identifying one or more alterable factors associated with the one or more assembly maneuvers;
generating an optimized assembly plan based, at least in part, on altering the one or more alterable factors associated with the one or more assembly maneuvers; and
assembling the object based on the optimized assembly plan.

2. The method of claim 1, further comprising:
generating one or more simulations associated with the object and assembly data, wherein the optimized assembly plan is based on the one or more simulations.

3. The method of claim 1, further comprising:
dynamically repositioning the one or more assembly robots, based on the optimized assembly plan.

4. The method of claim 1, wherein assembling the object, including:
analyzing the assembly data;
identifying a change associated with the object has occurred; and
simulating the change and the optimized assembly plan to determine an impact of the change on the optimized assembly plan.

5. The method of claim 4, further including:
updating the optimized assembly plan based on the impact to form an updated optimized assembly plan; and
dynamically repositioning the one or more assembly robots based on the updated optimized assembly plan.

6. The method of claim 1, wherein generating the optimized assembly plan includes:
simulating a particular assembly maneuver of the one or more assembly maneuvers;
determining an amount of time associated with performing the particular assembly maneuver, wherein the amount of time is an alterable factor;
identifying a substitute assembly maneuver, wherein the substitute assembly maneuver is performed in a different amount of time;
determining the different amount of time associated with the substitute assembly maneuver is less than the amount of time of the particular assembly maneuver; and
replacing the particular assembly maneuver with the substitute assembly maneuver.

7. The method of claim 1, wherein generating the optimized assembly plan includes:
simulating the assembly data and the one or more assembly maneuvers associated with assembling the object;
determining an assembly time associated with assembling the object using an initial number of the one or more assembly robots, wherein the initial number of the one or more assembly robots is an alterable factor; and
identifying an optimized number of the one or more assembly robots, wherein the optimized number of the one or more assembly robots is based on simulating the assembly data and the one or more assembly maneuvers associated with assembling the object.

8. A system, the system comprising:
a memory; and
a processor in communication with the memory, the processor being configured to perform operations comprising:
receiving assembly data associated with one or more assembly robots and an object, wherein the object is assembled by the one or more assembly robots performing one or more assembly maneuvers;
analyzing the assembly data and the one or more assembly maneuvers associated with assembling the object;
identifying one or more alterable factors associated with the one or more assembly maneuvers;
generating an optimized assembly plan based, at least in part, on altering the one or more alterable factors associated with the one or more assembly maneuvers; and
assembling the object based on the optimized assembly plan.

9. The system of claim 8, further comprising:
generating one or more simulations associated with the object and assembly data, wherein the optimized assembly plan is based on the one or more simulations.

10. The system of claim 8, further comprising:
dynamically repositioning the one or more assembly robots, based on the optimized assembly plan.

11. The system of claim 8, wherein assembling the object, including:
analyzing the assembly data;
identifying a change associated with the object has occurred; and
simulating the change and the optimized assembly plan to determine an impact of the change on the optimized assembly plan.

12. The system of claim 11, further including:
updating the optimized assembly plan based on the impact to form an updated optimized assembly plan; and
dynamically repositioning the one or more assembly robots based on the updated optimized assembly plan.

13. The system of claim 8, wherein generating the optimized assembly plan includes:
simulating a particular assembly maneuver of the one or more assembly maneuvers;
determining an amount of time associated with performing the particular assembly maneuver, wherein the amount of time is an alterable factor;
identifying a substitute assembly maneuver, wherein the substitute assembly maneuver is performed in a different amount of time;
determining the different amount of time associated with the substitute assembly maneuver is less than the amount of time of the particular assembly maneuver; and
replacing the particular assembly maneuver with the substitute assembly maneuver.

14. The system of claim 8, wherein generating the optimized assembly plan includes:
simulating the assembly data and the one or more assembly maneuvers associated with assembling the object;
determining an assembly time associated with assembling the object using an initial number of the one or more assembly robots, wherein the initial number of the one or more assembly robots is an alterable factor; and
identifying an optimized number of the one or more assembly robots, wherein the optimized number of the one or more assembly robots is based on simulating the assembly data and the one or more assembly maneuvers associated with assembling the object.

15. A computer program product, the computer program product comprising a computer readable storage medium having program instructions embodied therewith, the program instructions executable by a processor to cause the processors to perform a function, the function comprising:
receiving assembly data associated with one or more assembly robots and an object, wherein the object is assembled by the one or more assembly robots performing one or more assembly maneuvers;
analyzing the assembly data and the one or more assembly maneuvers associated with assembling the object;
identifying one or more alterable factors associated with the one or more assembly maneuvers;
generating an optimized assembly plan based, at least in part, on altering the one or more alterable factors associated with the one or more assembly maneuvers; and
assembling the object based on the optimized assembly plan.

16. The computer program product of claim 15, further comprising:
generating one or more simulations associated with the object and assembly data, wherein the optimized assembly plan is based on the one or more simulations.

17. The computer program product of claim 15, further comprising:
dynamically repositioning the one or more assembly robots, based on the optimized assembly plan.

18. The computer program product of claim 15, wherein assembling the object, including:
analyzing the assembly data;
identifying a change associated with the object has occurred; and
simulating the change and the optimized assembly plan to determine an impact of the change on the optimized assembly plan.

19. The computer program product of claim 18, further including:
updating the optimized assembly plan based on the impact to form an updated optimized assembly plan; and
dynamically repositioning the one or more assembly robots based on the updated optimized assembly plan.

20. The computer program product of claim 15, wherein generating the optimized assembly plan includes:
simulating a particular assembly maneuver of the one or more assembly maneuvers;
determining an amount of time associated with performing the particular assembly maneuver, wherein the amount of time is an alterable factor;
identifying a substitute assembly maneuver, wherein the substitute assembly maneuver is performed in a different amount of time;
determining the different amount of time associated with the substitute assembly maneuver is less than the amount of time of the particular assembly maneuver; and
replacing the particular assembly maneuver with the substitute assembly maneuver.
